(19) United States
(12) Patent Application Publication
(10) Pub. No.: US 2010/0230326 A1
(43) Pub. Date: Sep. 16, 2010

(54) OIL SANDS FLOTATION

(76) Inventors: Michael Francis Young, Queensland (AU); Le Vi Huynh, Brisbane (AU)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/598,619

(22) PCT Filed: May 16, 2008
(86) PCT No.: PCT/AU08/00689

§ 371 Date: May 21, 2010

(30) Foreign Application Priority Data
May 29, 2007 (AU) 2007902865

(51) Int. Cl. B03D 1/02; B03D 1/24; B03D 1/08

(52) U.S. Cl. 209/164; 209/170

(57) ABSTRACT

An oil sands flotation circuit wherein a feed stream is fed to a bank comprising at least one rougher flotation cell producing a rougher concentrate stream and a rougher tailings stream, said rougher concentrate stream being fed to a bank comprising at least one cleaner flotation cell producing a cleaner concentrate stream and a cleaner tailings stream.

### FIELD OF THE INVENTION

The present invention relates to a process and plant for the flotation of oil sands.

### BACKGROUND ART

Oil sands, also known as tar sands or bitumen sands, are one of the world's largest sources of crude oil. The vast majority of the world's oil sands reserves are found in North America, and Canada in particular, with some further reserves in South America.

Oil sands exist as a grain of sand surrounded by a thin layer of water and further surrounded by a layer of bitumen. Bitumen is a heavy, viscous crude oil that may be processed into high-quality synthetic oils used, for example, as automotive or jet fuel.

The process for extracting bitumen from the sand particles involves using a hot water flotation process. The collected bitumen concentrate is mixed with naphtha to thin the bitumen sufficiently to allow it to be pumped.

Typically, the flotation process used in oil sands processing comprises a single stage only, and no subsequent upgrading of concentrate quality is carried out in the flotation section. As a result, uncollected bitumen reports to the tailings stream, and significant amounts of sand are collected in the bitumen concentrate. This leads to two equally unattractive outcomes: the loss of unrecovered bitumen to tailings and additional downstream costs associated with removing entrained sand from the bitumen concentrate.

It will be clearly understood that, if a prior art publication is referred to herein, this reference does not constitute an admission that the publication forms part of the common general knowledge in the art in Australia or in any other country.

### OBJECT OF THE INVENTION

It is an object of the present invention to provide a process and plant for the flotation of oil sands which may overcome at least some of the abovementioned disadvantages, or provide a useful or commercial choice.

In a first aspect of the present invention there is provided an oil sands flotation circuit wherein a feed stream is fed to a bank comprising at least one rougher flotation cell, producing a rougher concentrate stream and a rougher tailings stream, said rougher concentrate stream being fed to a bank comprising at least one cleaner flotation cell, producing a cleaner concentrate stream and a cleaner tailings stream.

The cleaner tailings steam may be partly or wholly recycled to any suitable point in the flotation circuit. The point in the flotation circuit to which the cleaner tailings stream may be recycled may typically be chosen based on the metallurgical conditions in, and the performance of, the flotation circuit. However, in some preferred embodiments of the present invention, the cleaner tailings stream may be partly or wholly recycled to the head of the bank comprising the at least one rougher flotation cell, or to any other suitable point within the bank comprising at least one rougher flotation cell, and the cleaner concentrate stream may comprise the final flotation product.

In some embodiments of the present invention, the rougher tailings stream may be dewatered and the discharged to a tailings storage area. In an alternative embodiment of the invention, however, the rougher tailings stream may be discharged directly to a tailings storage area and the water may be decanted from the settled solids. The tailings storage area may comprise any suitable storage area, such as, but not limited to, a tank or dam.

In another preferred embodiment of the present invention, the rougher tailings stream may be fed to a bank comprising at least one scavenger flotation cell, producing a scavenger concentrate stream and a scavenger tailings stream. The rougher tailings stream may be fed to the head of the bank comprising at least one scavenger flotation cell, or to any other suitable point within the bank comprising at least one scavenger flotation cell.

Preferably, the scavenger concentrate stream is partly or wholly fed to either the bank comprising at least one cleaner flotation cell or the bank comprising at least one rougher flotation cell. The scavenger concentrate stream may be fed to either the head of the respective banks, or to any other suitable point within the banks.

In some embodiments of the present invention, the scavenger tailings stream may be dewatered and the discharged to a tailings storage area. In an alternative embodiment of the invention, however, the scavenger tailings stream may be discharged directly to a tailings storage area and the water may be decanted from the settled solids. The tailings storage area may comprise any suitable storage area, such as, but not limited to, a tank or darn.

In another embodiment of the present invention, the cleaner tailings stream may be partly or wholly combined with the scavenger tailings stream, said combined stream being partly or wholly dewatered then discharged to a tailings storage area. In an alternative embodiment of the invention, however, the partly or wholly combined cleaner and scavenger tailings stream may be discharged directly to a tailings storage area and the water may be decanted from the settled solids. The tailings storage area may comprise any suitable storage area, such as, but not limited to, a tank or dam.

In another embodiment of the present invention, the scavenger tailings stream may be partly or wholly recycled to the head of the bank comprising at least one scavenger flotation cell. Alternatively, the scavenger tailings stream may be fed to any other suitable point within the bank comprising at least one scavenger flotation cell.

Preferably, dewatering is carried out using a thickener. The thickener overflow stream may be recycled to any suitable point within the flotation circuit. In some embodiments of the invention, the thickener overflow stream may be partly or wholly recycled to the bank comprising at least one cleaner flotation cell. The recycling of at least part of the thickener overflow stream to the bank comprising at least one cleaner flotation cell may help to improve dilution cleaning in the bank comprising at least one cleaner flotation cell. In some embodiments of the invention wherein the thickener overflow stream is partly or wholly recycled to the bank comprising at least one cleaner flotation cell, water may be added to the thickener overflow stream.

In a preferred embodiment of the present invention, the flotation cells are naturally aspirated cells, such as, but not limited to, Jameson cells.

In another preferred embodiment of the present invention, the flotation cells are column cells, such as, but not limited to, those produced by manufacturers such as CESL and MinnovEX.

### BRIEF DESCRIPTION OF THE DRAWINGS

An embodiment of the invention will be described with reference to the following drawings in which:.

FIG. 1 illustrates an example of a possible oil sands flotation circuit flowsheet, with rougher, cleaner and scavenger flotation stages according to an embodiment of the present invention.

### BEST MODE

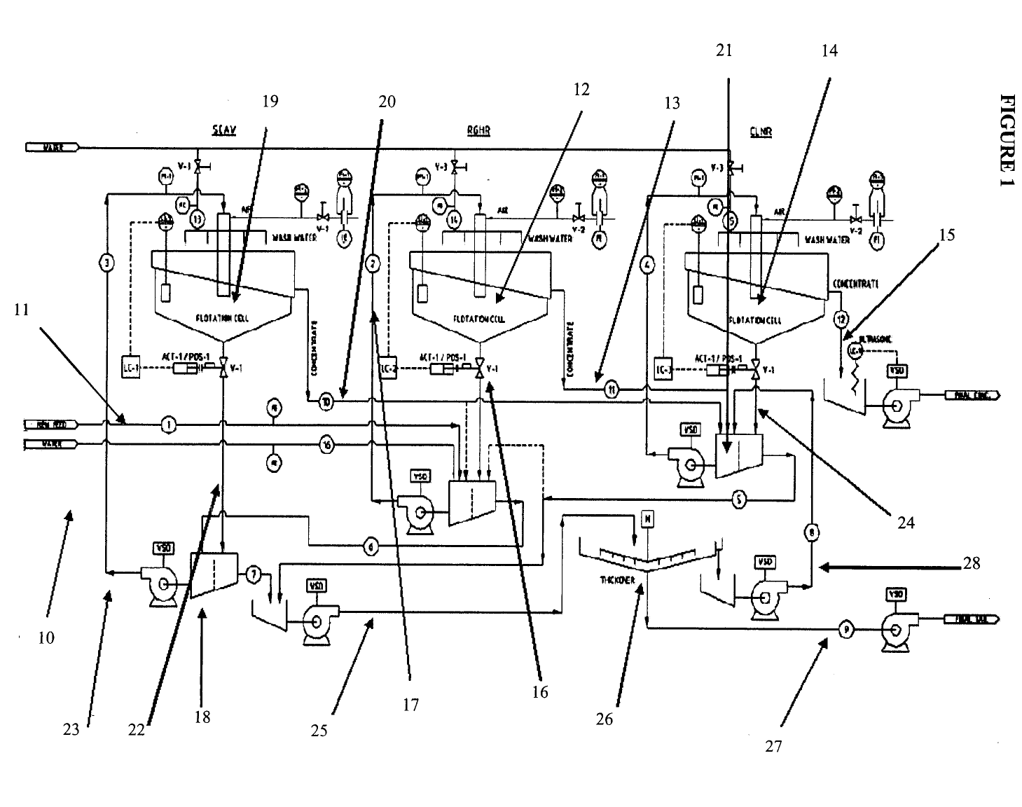

In the embodiment of the invention shown in FIG. 1 there is illustrated an oil sands flotation circuit 10 in which a fresh feed stream 11 is fed directly to the feed inlet of a rougher flotation cell 12. In the embodiment of the invention illustrated, the rougher flotation cell 12 is a Jameson cell.

The rougher flotation cell 12 produces a rougher concentrate stream 13 which is fed to the inlet of a cleaner flotation cell 14. In the embodiment of the invention illustrated, the cleaner flotation cell 14 is a Jameson cell. The cleaner flotation cell produces a cleaner concentrate stream 15 which represents the final flotation product of the circuit 10.

The rougher tailings stream 16 may either be partially or wholly recycled 17 to the feed inlet of the rougher flotation cell 12 or may be pumped to a tailings sump 18, from where at least a portion of the stream is pumped to the feed inlet of a scavenger flotation cell 19. In the embodiment of the invention illustrated, the scavenger flotation cell 19 is a Jameson cell.

The scavenger concentrate stream 20 is pumped to a cleaner feed sump 21, where it is combined with the rougher concentrate stream 13 to form the feed stream to the cleaner flotation cell 14.

The scavenger tailings stream 22 is fed to the tailings sump 18, from where it may be wholly or partially recycled 23 to the feed inlet of the scavenger flotation cell 19. Likewise, the cleaner tailings stream 24 may be partially or wholly recycled to the feed inlet of the cleaner flotation cell 14. Alternatively, the tailings streams from all flotation cells may be partially or wholly combined in the tailings sump 18, from where the combined tailings stream 25 is pumped to a thickener 26 for dewatering.

The thickened slurry that forms the thickener underflow stream 27 is discharged to a tailings storage area (not shown).

In the embodiment of the invention illustrated in FIG. 1, the thickener overflow stream 28 may be partially or wholly recycled to the feed inlet of the cleaner flotation cell 14.

The flotation circuit illustrated in FIG. 1 provides a number of advantages over existing oil sands flotation circuits. The inclusion of cleaner and scavenger flotation stages in the circuit provides significant increases in the recovery of bitumen, while at the same time increasing the quality of the bitumen concentrate by reducing the amount of sand collected in the flotation process. By reducing the amount of sand collected, significant savings can be made in the downstream processing steps, as the need for further treatment of the concentrate to remove sand may be reduced or removed altogether.

Furthermore, the use of Jameson cells in the flotation circuit provides clear advantages over prior art oil sands flotation circuits.

Jameson cells require significantly less maintenance than conventional mechanical flotation cells, thereby reducing the cost of ongoing maintenance and loss of production due to maintenance shutdowns. In addition, Jameson cells do not require the use of blowers or compressors (unlike with mechanical cells or columns), again saving on maintenance as well as operating costs.

Furthermore, the Jameson cell produces significantly improved contact between bitumen particles and air bubbles due to the high intensity mixing conditions in the downcomer. The high intensity agitation of the particles results in an increased probability of the particles coming into contact with the air bubbles compared to mechanical cells or flotation columns, that rely on long residence times for the collision to take place. This not only decreases the residence time of the flotation circuit, but also eliminates the requirements for large, energy-intensive mixing tanks prior to the flotation circuit required when using mechanical flotation cells. Additionally, due to the decreased residence time in the circuit, a flotation circuit utilizing Jameson cells requires fewer cells than for an equivalent sized circuit using mechanical flotation cells. This in turn reduces the footprint and associated infrastructure required for the flotation circuit.

Throughout the specification and the claims (if present), unless the context requires otherwise, the term “comprise”, or variations such as “comprises” or “comprising”, will be understood to apply the inclusion of the stated integer or group of integers but not the exclusion of any other integer or group of integers.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

1. An oil sands flotation circuit wherein a feed stream is fed to a bank comprising at least one rougher flotation cell producing a rougher concentrate stream and a rougher tailings stream, said rougher concentrate stream being fed to a bank comprising at least one cleaner flotation cell producing a cleaner concentrate stream and a cleaner tailings stream, and wherein the cleaner concentrate stream comprises the final flotation product of the flotation circuit.

2. An oil sands flotation circuit according to claim 1 wherein the cleaner tailings stream is at least partly recycled to said bank comprising at least one rougher flotation cell.

3. An oil sands flotation circuit according to claim 1 wherein the rougher tailings stream is discharged to a tailings storage area.

4. An oil sands flotation circuit according to claim 3 wherein the rougher tailings stream is at least partly dewatered prior to being discharged to the tailings storage area.

5. An oil sands flotation circuit according claim 1 wherein said rougher tailings stream is partly or wholly fed to a bank comprising at least one scavenger flotation cell producing a scavenger concentrate stream and a scavenger tailings stream.

6. An oil sands flotation circuit according to claim 5 wherein the scavenger concentrate stream is at least partly recycled to either said bank comprising at least one rougher flotation cell or said bank comprising at least one cleaner flotation cell.

7. An oil sands flotation circuit according to claim 5 wherein the scavenger tailings stream is discharged to a tailings storage area.

8. An oil sands flotation circuit according to claim 7 wherein the scavenger tailings stream is at least partly dewatered prior to being discharged to the tailings storage area.

9. An oil sands flotation circuit according to claim 5 wherein the cleaner tailings stream is at least partly combined with the scavenger tailings stream, wherein the combined tailings stream is discharged to a tailings storage area.

10. An oil sands flotation circuit according to claim 9 wherein the combined tailings stream is at least partly dewatered prior to being discharged to the tailings storage area.

11. An oil sands flotation circuit according to claim 5, wherein the scavenger tailings stream is at least partly recycled to the bank comprising at least one scavenger flotation cell.

12. An oil sands flotation circuit according to claim 4 wherein dewatering is carried out in a thickener.

13. An oil sands flotation circuit according to claim 12 wherein a thickener overflow stream is at least partly recycled to said bank comprising at least one cleaner flotation cell.

14. An oil sands flotation circuit according to claim 1 wherein the at least one rougher floatation cell and the at least one cleaner floatation cell include Jameson cells.

15. An oil sands flotation circuit according to claim 1 wherein the at least one rougher floatation cell and the at least one cleaner floatation cell include column cells.

16. An oil sands floatation system comprising:
at least one rougher flotation cell having a feed inlet to receive a fresh feed stream, said at least one rougher floatation cell configured to produce a rougher concentrate stream and a rougher tailings stream; and
at least one cleaner flotation cell included in a bank to produce a cleaner concentrate stream and a cleaner tailings stream, said rougher concentrate stream being fed to said bank, said cleaner concentrate stream comprising the final floatation product of the floatation system.

17. An oil sands floatation system according to claim 16, wherein one or more of the at least one rougher floatation cell and the cleaner floatation cell include one or more of: a Jameson cell and a column cell.

18. An oil sands flotation system according to claim 16, further comprising:
a tailings storage area to receive the rougher tailings stream.

19. A method to process oil sands, the method comprising:
directing a feed stream to at least one rougher flotation cell;
producing, by the rougher floatation cell, a rougher concentrate stream and a rougher tailings stream;
directing the rougher concentrate stream to at least one cleaner flotation cell; and
producing, by the cleaner floatation cell, a cleaner concentrate stream and a cleaner tailings stream, said cleaner concentrate stream comprising the final floatation product of the method.

20. A method according to claim 19, wherein one or more of the at least one rougher floatation cell and the at least one cleaner floatation cell include one or more of: a Jameson cell and a column cell.
